(19) United States
(12) Patent Application Publication
(10) Pub. No.: US 2006/0168924 A1
(43) Pub. Date: Aug. 3, 2006

(54) Wire gauze filter assembly

(76) Inventor: Shin-Ching Sun, Taipei (TW)

Correspondence Address: SHIN-CHING SUN;5 FL., 755 MIN TZU E. ROAD, P. O. BOX 24-108, TAIPEI, TW

(21) Appl. No.: 11/047,489

(22) Filed: Feb. 1, 2005

(51) Int. Cl. B01D 46/00

(52) U.S. Cl. 55/486

(57) ABSTRACT

A wire gauze filter assembly is disclosed to include an open frame, a plurality of wire gauze filter elements made of paper, nonwoven fabric, fire netting material, or plastics in the form of a meshed, honeycomb, or wave-like structure and mounted inside the open frame, and a filter compound selected from chitosan, photocatalyst, active carbon, nanometered gold, nanometered silver, bee propolis, nanometered TiO₂Ag, nanometered TiO₂Au, nanometered TiO₂Pt, static filter compound, and/or their combination and coated on the wire gauze filter elements.

### BACKGROUND OF THE INVENTION

1. Field of the Invention

The present invention relates generally to air filter devices and more specifically, to a wire gauze filter assembly which is formed of a frame, a plurality of wire gauze filter elements arranged in the frame, and a filter compound coated on the wire gauze filter element for removing odor and toxic substances from the air and kills microbes and germs in the air.

2. Description of the Related Art

Regular wire gauze filters for use in windows may be covered with a layer of active carbon or titanium oxide for removing solid matter from the air. These designs of wire gauze filters cannot effectively remove toxic substances from the air or kill germs and microbes in the air. For use in different environments, different types of wire gauze filters should be used to fit different requirements. For example, in a chemical or high-tech industrial zone, wire gauze filters must be made capable of removing toxic substances and unpleasant smell from the air. For home use, wire gauze filters must be capable of killing germs and microbes and removing unpleasant smell.

### SUMMARY OF THE INVENTION

The present invention has been accomplished under the circumstances in view. It is therefore the main object of the present invention to provide a wire gauze filter assembly, which effectively removes unpleasant smell and toxic substances from the air and kills microbes and germs in the air.

To achieve this and other objects of the present invention, the wire gauze filter assembly comprises an open frame; a plurality of wire gauze filter elements mounted inside the open frame, the wire gauze filter elements being made in the form of one of meshed, honeycomb, and wave-like structures and selected from a material group including paper, nonwoven fabric, fire netting material, and plastics; and. a filter compound coated on the wire gauze filter elements, the filter compound including chitosan, photocatalyst, active carbon, nanometered gold, nanometered silver, bee propolis, nanometered TiO₂Ag, nanometered TiO₂Au, nanometered TiO₂Pt, static filter compound, and their combination. Further, the wire gauze filter elements can be mounted inside the frame side by side on the same plane, or arranged in a stack inside the frame, or with a number of the wire gauze filter elements arranged side by side on the same plate between the other two wire gauze filter elements inside the frame.

### BRIEF DESCRIPTION OF THE DRAWINGS

FIG. 1 is an exploded view of a wire gauze filter according to the present invention.

FIG. 2 is an exploded view of an alternate form of the wire gauze filter according to the present invention.

FIG. 3 is an exploded view of another alternate form of the wire gauze filter according to the present invention.

### DETAILED DESCRIPTION OF THE INVENTION

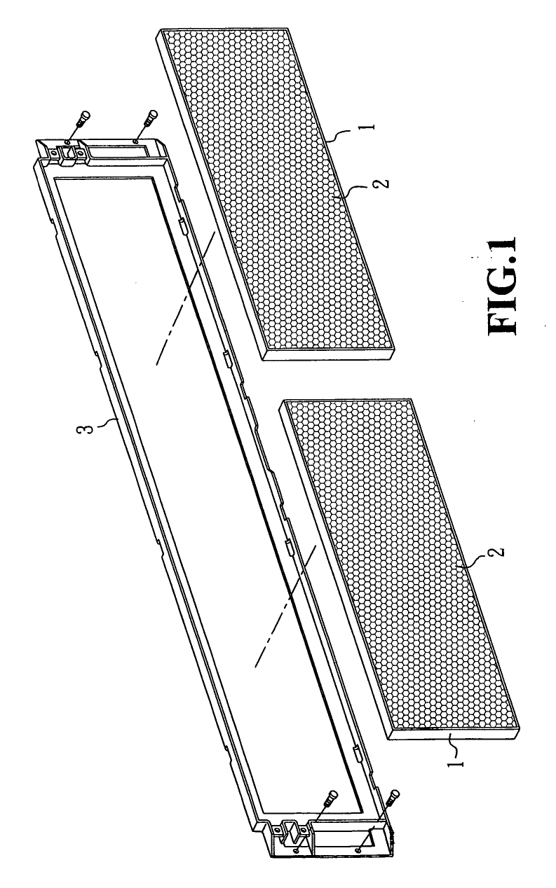

Referring to FIGS. 1˜3, a wire gauze filer assembly in accordance with the present invention is shown comprised of a plurality of wire gauze filter elements 1, a filter compound 2, and a frame 3.

The wire gauze filter elements 1 can be made of any of a variety of materials such as paper, nonwoven fabric, fire netting material, plastics and etc., in the form of a meshed structure of honeycomb, wave-like, or any of a variety of patterns.

The filter compound 2 can be chitosan, photocatalyst, active carbon, nanometered gold, nanometered silver, bee propolis, nanometered TiO₂Ag, nanometered TiO₂Au, nanometered TiO₂Pt, static filter compound, and/or their combination. Chitosan is capable of absorbing unpleasant smell, radiation and heavy metal particles from the air and killing microbes in the air. Photocatalyst is capable of oxidizing dead microbes into carbon dioxide and water for vaporization. Bee propolis is a natural antibiotic and cleaning material that is protective against external toxic substances. Active carbon provides the function of removing odor. Nanometered gold can eliminate the effect of carbon monoxide. Nanometered silver kills germs. The filter compound 2 is coated on the wire gauze filter elements 1 by any of a variety of coating techniques including spray coating and immersion plating. After coating of the filter compound 2 on the wire gauze filter elements 1, the wire gauze filter elements 1 are well dried and mounted inside the frame 3.

The frame 3 is an open frame of any of a variety of shapes and sizes to fit any of a variety of windows.

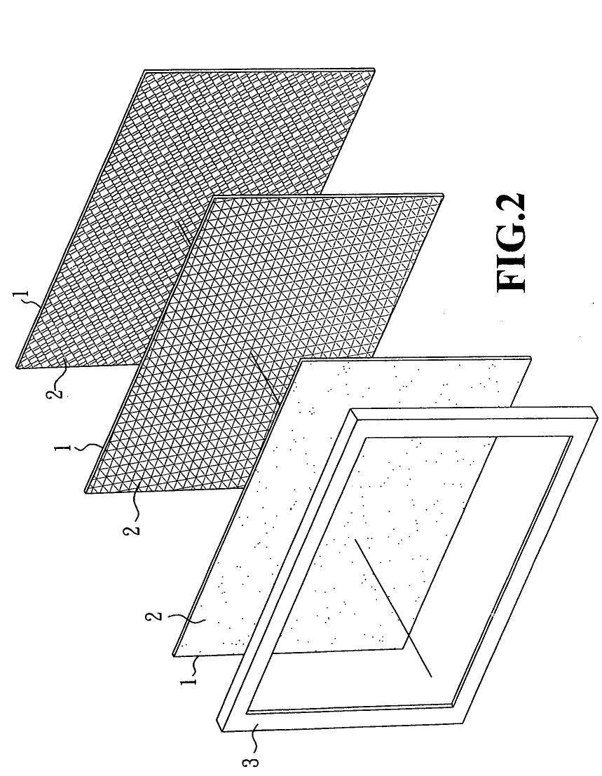

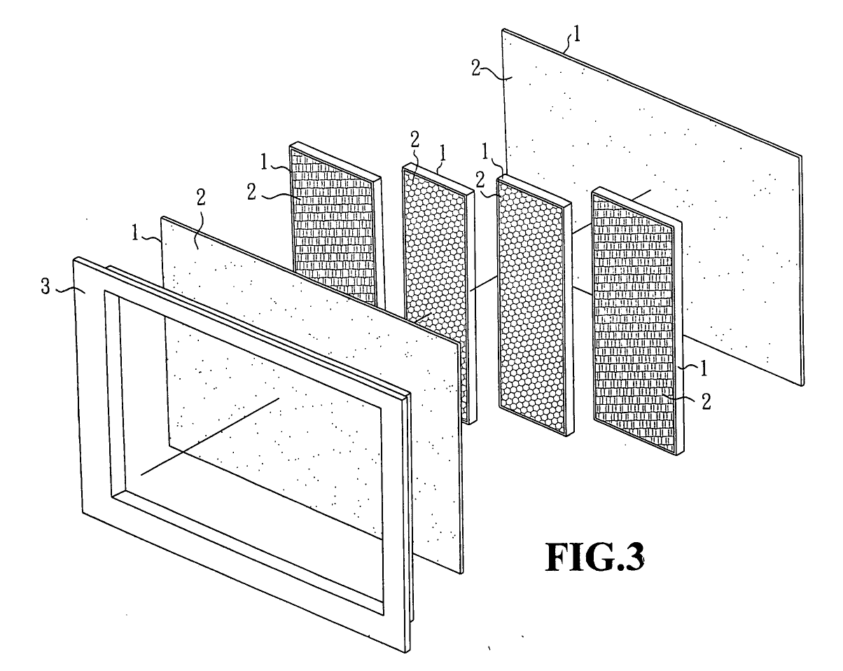

Further, the wire gauze filter elements 1 can be mounted inside the frame 3 side by side on the same plane as shown in FIG. 1, or arranged in a stack inside the frame 3 as shown in FIG. 2, or with a number of the wire gauze filter elements 1 arranged side by side on the same plate between the other two wire gauze filter elements 1 inside the frame 2 as shown in FIG. 3.

Further, for use in an environment where kerosene oil stove or wall stove is used, it is recommend to have the wire gauze filter assembly be equipped with wire gauze filter elements that contain a big amount of nanometered TiO₂Au, nanometered TiO₂Pt, and active carbon. Preferably, nanometered TiO₂Au, nanometered TiO₂Pt, and active carbon are supported on filter cotton. Nanometered TiO₂Au and nanometered TiO₂Pt reduce toxic CO to CO₂ that is not harmful to human beings.

A prototype of wire gauze filter assembly has been constructed with the features of FIGS. 1˜3. The wire gauze filter assembly functions smoothly to provide all of the features discussed earlier.

Although particular embodiments of the invention have been described in detail for purposes of illustration, various modifications and enhancements may be made without departing from the spirit and scope of the invention. For example, oscillator means may be used to atomize water into a fine spray. Accordingly, the invention is not to be limited except as by the appended claims.

What is claimed is:

1. A wire gauze filter assembly comprising:
an open frame;
a plurality of wire gauze filter elements mounted inside said open frame, said wire gauze filter elements being made in the form of one of meshed, honeycomb, and wave-like structures and selected from a material group including paper, nonwoven fabric, fire netting material, and plastics; and.
a filter compound coated on said wire gauze filter elements, said filter compound including chitosan, photocatalyst, active carbon, nanometered gold, nanometered silver, bee propolis, nanometered TiO₂Ag, nanometered TiO₂Au, nanometered TiO₂Pt, static filter compound, and their combination.

2. The wire gauze filter assembly as claimed in claim 1, wherein said wire gauze filter elements are arranged in a stack inside said frame.

3. The wire gauze filter assembly as claimed in claim 1, wherein said wire gauze filter elements include a front wire gauze filter element and a rear wire gauze filter element respectively mounted in front and rear sides inside said frame, and a plurality of intermediate wire gauze filter elements arranged in a stack inside said frame between said front wire gauze filter element and said rear wire gauze filter element.
